(19) United States
(12) Patent Application Publication
(10) Pub. No.: US 2022/0275009 A1
(43) Pub. Date: Sep. 1, 2022

(54) CATIONIC GERMANIUM(II) COMPOUNDS, PROCESS FOR PREPARING SAME, AND THEIR USE AS CATALYSTS IN HYDROSILYLATION

(71) Applicant: Wacker Chemie AG, Munich (DE)

(72) Inventors: Elke Fritz-Langhals, Ottobrunn (DE); Richard Weidner, Burghausen (DE); Sven Werge, Aichach (DE)

(73) Assignee: Wacker Chemie AG, Munich (DE)

(21) Appl. No.: 17/609,982

(22) PCT Filed: May 10, 2019
(86) PCT No.: PCT/EP2019/062003

§ 371 Date: Nov. 9, 2021

(51) Int. Cl. C07F 7/08; B01J 31/14; B01J 31/22; C07F 17/00

(52) U.S. Cl. CPC C07F 7/0896; B01J 31/146; B01J 31/2295; B01J 2540/22; B01J 2231/323; B01J 2531/40; C07F 17/00

(57) ABSTRACT

A mixture M includes at least one compound A, selected from (a1) a compound of the general formula (I) and/or (a2) a compound of the general formula (I′), at least one compound B, selected from (b1) a compound of the general formula (II) and/or (b2) a compound of the general formula (II′) and/or (b3) a compound of the general formula (II″), and at least one compound C, selected from cationic germanium(II) compounds of the general formula (III).

The addition of hydrosilicon compounds to unsaturated organic compounds such as alkenes and alkynes plays an important role in technology. This reaction, referred to as hydrosilylation, is used, for example, to crosslink siloxanes and to introduce functional groups into silanes or siloxanes. In general, hydrosilylations only proceed catalyzed. In the prior art, primarily platinum, rhodium or iridium complexes are used as catalysts, which make the process considerably more expensive. In addition, noble metals are only available to a limited extent as raw materials and are subject to price fluctuations that cannot be foreseen or influenced. Noble metal-free catalyst systems are therefore of great technical interest for hydrosilylations.

It is known from WO2017/174290 that cationic silicon(II) compounds catalyze hydrosilylations.

Angew. Chem. Int. Ed. 2017, 56, 1365 describes the hydrosilylation of trifluoroacetophenone and of CO₂ in the presence of a heterocyclic germylene donor-stabilized by phosphorus and nitrogen moities, which has an electrically neutral germanium center. In these compounds, the phosphorus center represents the catalysis center, which activates the silicon-hydrogen compound for the hydrosilylation process.

One problem with the noble metal-free catalysts described above is that they are extremely sensitive to air and moisture. Their use therefore requires special measures that ensure exclusion of air and moisture. This increases the technical complexity involved in their production and use. In addition, they or their precursors are only accessible via complex, multi-stage syntheses and are therefore not technically widely applicable.

It was therefore an object of the present invention to provide compounds as catalysts for hydrosilylation which do not have the disadvantages of the catalysts known to date.

A further object of the present invention was to provide novel mixtures which can hydrosilylate.

It has been found that cationic germanium(II) compounds catalyze hydrosilylations in the presence of oxygen.

It has also been found that cationic germanium(II) compounds are stable as solids in air for several days. This is surprising since the corresponding silicon(II) compounds decompose very rapidly in air. The germanium(II) compounds according to the invention constitute a considerable technical advantage.

Some germanium(II) compounds with inorganic anions and a method for the preparation thereof have already been described by Jutzi et al. in Organometallics 1986, 5, 730. Cp*Ge⁺ BF₄⁻ is obtained in 54% yield by reacting pentamethylcyclopentadienylgermanium chloride with HBF₄ at −80° C., Cp*Ge⁺ AlCl₄⁻ is obtained in 42% yield by reacting pentamethylcyclopentadienylgermanium chloride with aluminum trichloride, and Cp*Ge⁺ GeCl₃⁻ is obtained in 92% yield by reacting pentamethylcyclopentadienylgermanium chloride with germanium dichloride-dioxane complex. However, these access routes are very specific and cationic germanium(II) compounds with organic anions are not accessible in this manner. A general, simple strategy with which a wide number of different compounds may be prepared, in particular those having an organic anion, is thus currently unknown.

It was therefore a further object of the present invention to provide a method with which a large number of cationic germanium(II) compounds are accessible in a simple manner.

The stated objects are achieved by the subject matter of the patent claims.

The present invention relates to a mixture M

comprising
(a) at least one compound A selected from
(a1) a compound of the general formula (I)

R¹R²R³Si—H (I),

in which the radicals R¹, R² and R³ are each independently selected from the group consisting of (i) hydrogen, (ii) halogen, (iii) unsubstituted or substituted C₁-C₂₀-hydrocarbon radical, and (iv) unsubstituted or substituted C₁-C₂₀-hydrocarbonoxy radical, where two of the radicals R¹, R² and R³ may also form with each other a monocyclic or polycyclic, unsubstituted or substituted C₂-C₂₀-hydrocarbon radical, wherein substituted means in each case that the hydrocarbon or hydrocarbonoxy radical each independently has at least one of the following substitutions: a hydrogen atom can be replaced by halogen, —C≡N, —OR^{z}, —SR^{z}, —NR^{z}₂, —PR^{z}₂, —O—CO—R^{z}, —NH—CO—R^{z}, —O—CO—OR^{z} or —COOR^{z}, a CH₂ group can be replaced by —O—, —S— or —NR^{z}—, and a carbon atom can be replaced by a Si atom, in which R^{z} is in each case independently selected from the group consisting of hydrogen, C₁-C₆-alkyl radical, C₆-C₁₄-aryl radical, and C₂-C₆-alkenyl radical; and/or
(a2) a compound of the general formula (I′)

(SiO_{4/2})ₐ(R^{x}SiO_{3/2})_{b}(HSiO_{3/2})_{b′}(R^{x}₂SiO_{2/2})_{c}(R^{x}HSiO_{2/2})_{c′}(H₂SiO_{2/2})_{c″}(R^{x}₃SiO_{1/2})_{d}(HR^{x}₂SiO_{1/2})_{d′}(H₂R^{x}SiO_{1/2})_{d″}(H₃SiO_{1/2})_{d′″} (I′),

in which the radicals R^{x} are each independently selected from the group consisting of (i) halogen, (ii) unsubstituted or substituted C₁-C₂₀-hydrocarbon radical, and (iii) unsubstituted or substituted C₁-C₂₀-hydrocarbonoxy radical, where substituted means in each case that the hydrocarbon or hydrocarbonoxy radical each independently has at least one of the following substitutions: a hydrogen atom can be replaced by halogen, a CH₂ group can be replaced by —O— or —NR^{z}—, in which R^{z} is in each case independently selected from the group consisting of hydrogen, C₁-C₆-alkyl radical, C₆-C₁₄-aryl radical, and C₂-C₆-alkenyl radical; and in which the indices a, b, b′, c, c′, c″, d, d′, d″, d′″ specify the number of the respective siloxane unit in the compound and are each independently an integer in the range from 0 to 100 000, with the proviso that the sum of a, b, b′, c, c′, c″, d, d′, d″, d′″ together has the value of at least 2 and at least one of the indices b′, c′, c″, d′, d″ or d′″ is not equal to 0; and
(b) at least one compound B selected from
(b1) a compound of the general formula (II)

R⁴R⁵C═CR⁶R⁷ (II), and/or

(b2) a compound of the general formula (II′)

R⁸C≡CR⁹ (II′),

in which the radicals R⁴, R⁵, R⁶, R⁷, R⁸ and R⁹ are each independently selected from the group consisting of (i) hydrogen, (ii) —C≡N, (iii) organosilicon radical having 1-100 000 silicon atoms, (iv) unsubstituted or substituted C₁-C₂₀-hydrocarbon radical, and (v) unsubstituted or substituted C₁-C₂₀-hydrocarbonoxy radical, where two of the radicals R⁴, R⁵, R⁶ and R⁷ may also form with each other a monocyclic or polycyclic, unsubstituted or substituted C₂-C₂₀-hydrocarbon radical, wherein substituted means in each case that the hydrocarbon or hydrocarbonoxy radical each independently has at least one of the following substitutions: a hydrogen atom can be replaced by halogen, —C≡N, —OR^{z}, —SR^{z}, —NR^{z}₂, —PR^{z}₂, —O—CO—R, —NH—CO—W, —O—CO—OR^{z}, —COOR^{z} or —[O—(CH₂)ₙ]ₒ—(CH(O)CH₂) where n=1-6 and o=1-100, a CH₂ group can be replaced by —O—, —S— or —NR^{z}—, and a carbon atom can be replaced by a Si atom, in which R^{z} is in each case independently selected from the group consisting of hydrogen, C₁-C₆-alkyl, C₆-C₁₄-aryl, and C₂-C₆-alkenyl; and/or
(b3) a compound of the general formula (II″)

R^{x}₃Si—O[—SiR^{x}₂—O]ₘ—[Si(MB)R^{x}—O]ₙ—SiR^{x}₃ (II″),

in which the radicals R^{x} are each independently selected from the group consisting of (i) hydrogen, (ii) halogen, (iii) MB, (iv) unsubstituted or substituted C₁-C₂₀-hydrocarbon radical, and (v) unsubstituted or substituted C₁-C₂₀-hydrocarbonoxy radical;
and in which MB is each independently (i) —(CH₂)ₒ—CR═CR₂ or (ii) —(CH₂)ₒ—C≡CR, where o=0-12 and in which R is in each case independently selected from the group consisting of (i) hydrogen, (ii) halogen, (iii) unsubstituted or substituted C₁-C₂₀-hydrocarbon radical, and (iv) unsubstituted or substituted C₁-C₂₀-hydrocarbonoxy radical, wherein substituted means in each case that the hydrocarbon or hydrocarbonoxy radical each independently has at least one of the following substitutions: a hydrogen atom can be replaced by halogen, —C≡N, —OR^{z}, —SR^{z}, —NR^{z}₂, —PR^{z}₂, —O—CO—R^{z}, —NH—CO—R^{z}, —O—CO—OR^{z} or —COOR^{z}, a CH₂ group can be replaced by —O—, —S— or —NR^{z}—, and a carbon atom can be replaced by a Si atom, in which R^{z} is in each case independently selected from the group consisting of hydrogen, C₁-C₆-alkyl radical, C₆-C₁₄-aryl radical, and C₂-C₆-alkenyl radical,
and in which m and n are each independently an integer in the range from 0 to 100 000, with the proviso that at least one radical MB is present in the compound; and
(c) at least one compound C selected from cationic germanium(II) compounds of the general formula (III)

([Ge(II)Cp]⁺)ₐX^{a-} (III),

in which Cp is a π-bonded cyclopentadienyl radical of the general formula (IIIa)

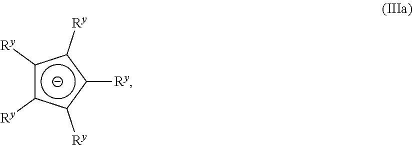

in which the radicals R^{y} are each independently selected from the group consisting of (i) triorganosilyl radical of the formula —SiR^{b}₃, in which the radicals R^{b} are each independently C₁-C₂₀-hydrocarbon radical, (ii) hydrogen, (iii) unsubstituted or substituted C₁-C₂₀-hydrocarbon radical, and (iv) unsubstituted or substituted C₁-C₂₀-hydrocarbonoxy radical, wherein in each case two radicals R^{y} can also form with each other a monocyclic or polycyclic C₂-C₂₀-hydrocarbon radical, and wherein substituted means in each case that in the hydrocarbon or hydrocarbonoxy radical also at least one carbon atom can be replaced by a Si atom,
X^{a-} is an a valent anion; and
a can have the values 1, 2 or 3.

Compound A

At least one compound A is present in the mixture M, which also includes mixtures of compounds of the general formula (I) and/or mixtures of compounds of the general formula (I′).

In formula (I), the radicals R¹, R² and R³ are preferably each independently selected from the group consisting of (i) hydrogen, (ii) chlorine, (iii) unsubstituted or substituted C₁-C₁₂-hydrocarbon radical, and (iv) unsubstituted or substituted C₁-C₁₂-hydrocarbonoxy radical, wherein substituted has the same definition as before; and in formula (I′) the radicals R^{x} are preferably each independently selected from the group consisting of chlorine, C₁-C₆-alkyl radical, C₂-C₆-alkenyl radical, phenyl, and C₁-C₆-alkoxy radical, and the indices a, b, b′, c, c′, c″, d, d′, d″, d′″ are each independently selected from an integer in the range of 0 to 1000.

In formula (I) the radicals R¹, R² and R³ are particularly preferably each independently selected from the group consisting of (i) hydrogen, (ii) chlorine, (iii) C₁-C₆-alkyl radical, (iv) C₂-C₆-alkenyl radical, (v) phenyl, and (vi) C₁-C₆-alkoxy radical; and in formula (I′) the radicals R^{x} are particularly preferably each independently selected from the group consisting of chlorine, methyl, methoxy, ethyl, ethoxy, n-propyl, n-propoxy, and phenyl, and the indices a, b, b′, c, c′, c″, d, d′, d″, d′″ are each independently selected from an integer in the range from 0 to 1000.

In formula (I) the radicals R¹, R² and R³ and in formula (I′) the radicals R^{x} are especially preferably each independently selected from the group consisting of hydrogen, chlorine, methyl, methoxy, ethyl, ethoxy, n-propyl, n-propoxy, and phenyl, and the indices a, b, b′, c, c′, c″, d, d′, d″, d′″ are preferably each independently selected from an integer in the range from 0 to 1000.

A mixture of compounds of the formula (I′) is present, particularly in the case of polysiloxanes. For the sake of simplicity, however, the individual compounds of the mixture are not specified for polysiloxanes, but an average formula (I′a) similar to the formula (I′) is given:

(SiO_{4/2})ₐ(R^{x}SiO_{3/2})_{b}(HSiO_{3/2})_{b′}(R^{x}₂SiO_{2/2})_{c}(R^{x}HSiO_{2/2})_{c′}(H₂SiO_{2/2})_{c″}(R^{x}₃SiO_{1/2})_{d}(HR^{x}₂SiO_{1/2})_{d′}(H₂R^{x}SiO_{1/2})_{d″}(H₃SiO_{1/2})_{d′″} (I′a),

in which the radicals R^{x} have the same definition as in formula (I′), but the indices a, b, b′, c, c′, c″, d, d′, d″, d′″ are each independently a number in the range of 0 to 100 000 and specify the average content of the respective siloxane unit in the mixture. Preference is given to those mixtures of the average formula (I′a), in which the indices a, b, b′, c, c′, c″, d, d′, d″, d′″ are each independently selected from a number in the range of 0 to 20 000.

Examples of compounds A of the general formula (I) are the following silanes (Ph=phenyl, Me=methyl, Et=ethyl): Me₃SiH, Et₃SiH, Me₂PhSiH, MePh₂SiH, Me₂ClSiH, Et₂ClSiH, MeCl₂SiH, Cl₃SiH, Me₂(MeO)SiH, Me(MeO)₂SiH, (MeO)₃SiH, Me₂(EtO)SiH, Me(EtO)₂SiH, (EtO)₃SiH; and examples of compounds A of the general formula (I′) are the following siloxanes and polysiloxanes:

HSiMe₂-O—SiMe₂H, Me₃Si—O—SiHMe₂, Me₃Si—O—SiHMe-O—SiMe₃,
H—SiMe₂-(O—SiMe₂)ₘ-O—SiMe₂-H, in which m is a number in the range of 1 to 20 000,
Me₃Si—O—(SiMe₂-O)ₙ(SiHMe-O)ₒ—SiMe₃, in which n and o are each independently a number in the range of 1 to 20 000.

Compound B

At least one compound B is present in the mixture M, which also includes mixtures of compounds of the general formula (II) and/or mixtures of compounds of the general formula (II′) and/or mixtures of compounds of the general formula (II″).

Organosilicon radical in formula (II′) means a compound having at least one direct Si—C bond in the molecule.

In the formulae (II) and (II′) the radicals R⁴, R⁵, R⁶, R⁷, R⁸ and R⁹ are preferably each independently selected from the group consisting of (i) hydrogen, (ii) —C≡N, (iii) unsubstituted or substituted C₁-C₁₂-hydrocarbon radical, (iv) unsubstituted or substituted C₁-C₁₂-hydrocarbonoxy radical, wherein substituted means in each case that the hydrocarbon or hydrocarbonoxy radical each independently has one of the following substitutions: a hydrogen atom can be replaced by halogen, —C≡N, C₁-C₆-alkoxy, —NR^{z}₂, —O—CO—R^{z}, —NH—CO—R^{z}, —O—CO—OR^{z}, —COOR^{z} or —[O—(CH₂)ₙ]ₒ—(CH(O)CH₂) where n=1-3 and o=1-20, in which R^{z} is in each case independently selected from the group consisting of hydrogen, chlorine, C₁-C₆-alkyl, C₂-C₆-alkenyl, and phenyl; and (v) organosilicon radical selected from the general formula (IIa),

(CH₂)ₙ—SiR^{x}₃ (IIa),

in which the radicals R^{x} are each independently selected from the group consisting of (i) hydrogen, (ii) halogen, (iii) unsubstituted or substituted C₁-C₂₀-hydrocarbon radical, and (iv) unsubstituted or substituted C₁-C₂₀-hydrocarbonoxy radical, wherein substituted means in each case that the hydrocarbon or hydrocarbonoxy radical each independently has at least one of the following substitutions: a hydrogen atom can be replaced by halogen, a CH₂ group can be replaced by —O— or —NR^{z}—, in which R^{z} is selected from the group consisting of hydrogen, C₁-C₆-alkyl, C₆-C₁₄-aryl, and C₂-C₆-alkenyl;
and in which n=0-12;
and in formula (II″) the radicals R^{x} are preferably each independently selected from the group consisting of (i) hydrogen, (ii) chlorine, (iii) C₁-C₆-alkyl radical, (iv) phenyl, (v) MB and (vi) C₁-C₆-alkoxy radical, where MB is in each case independently (i) —(CH₂)ₒ—CR═CR₂ or (ii) —(CH₂)ₒ—C≡CR, where o=0-6 and in which R is in each case independently selected from the group consisting of (i) hydrogen, (ii) chlorine, (iii) C₁-C₆-alkyl radical, (iv) phenyl, and (v) C₁-C₆-alkoxy radical.

In the formulae (II) and (II′) the radicals R⁴, R⁵, R⁶, R⁷, R⁸ and R⁹ are particularly preferably each independently selected from the group consisting of (i) hydrogen, (ii) —C≡N, (iii) organosilicon radical selected from the general formula (IIa), in which the radicals R^{x} are each independently selected from the group consisting of hydrogen, chlorine, C₁-C₆-alkyl radical, C₂-C₆-alkenyl radical, phenyl and C₁-C₆-alkoxy radical; (iv) unsubstituted or substituted C₁-C₆-hydrocarbon radical, and (v) unsubstituted or substituted C₁-C₆-hydrocarbonoxy radical, wherein substituted means in each case that the hydrocarbon or hydrocarbonoxy radical has each independently at least one of the following substitutions: a hydrogen atom can be replaced by chlorine, —C≡N, —O—CH₂—(CH(O)CH₂) (=glycidoxy radical), —NR^{z}₂ and —O—CO—R^{z}, wherein R^{z} is in each case independently selected from the group consisting of hydrogen and C₁-C₆-alkyl;

and in formula (II″) the radicals R^{x} are particularly preferably each independently selected from the group consisting of C₁-C₃-alkyl radical and MB, where MB is in each case —(CH₂)ₒ—CR═CR₂, in which R is in each case hydrogen and o=0-6.

Examples of compounds of the formula (II″) are

R^{x}₃Si—O[—SiR^{x}₂—O]ₘ—[Si(MB)₂—O]₁₋₁₀₀₀₀₀—SiR^{x}₃,
R^{x}₃Si—O[—SiR^{x}₂—O]ₘ—[Si(MB)R^{x}—O]₁₋₁₀₀₀₀₀—SiR^{x}₃,
(MB)R^{x}₂Si—O[—SiR^{x}₂—O]ₘ—[Si(MB)R^{x}—O]ₙ—SiR^{x}₃,
(MB)R^{x}₂Si—O[—SiR^{x}₂—O]ₘ—[Si(MB)₂—O]ₙ—SiR^{x}₃,
(MB)R^{x}₂Si—O[—SiR^{x}₂—O]ₘ—[Si(MB)R^{x}—O]ₙ—SiR^{x}₂(MB),
(MB)R^{x}₂Si—O[—SiR^{x}₂—O]ₘ—[Si(MB)₂—O]ₙ—SiR^{x}₂(MB),
in which MB in each case is each independently (i) —(CH₂)ₒ—CR═CR₂ or (ii) —(CH₂)ₒ—C≡CR, where o=0-12 and in which R^{x}, m and n have the same definition as in formula (II″).

Examples of compounds B are ethylene, propylene, 1-butylene, 2-butylene, isoprene, 1,5-hexadiene, cyclohexene, dodecene, cycloheptene, norbomene, norbornadiene, indene, cyclooctadiene,

styrene, α-methylstyrene, 1,1-diphenylethylene, cis-stilbene, trans-stilbene, 1,4-divinylbenzene, allylbenzene,
allyl chloride, allylamine, dimethylallylamine, acrylonitrile, allyl glycidyl ether, vinyl acetate, vinyl-Si(CH₃)₂OMe, vinyl-SiCH₃(OMe)₂, vinyl-Si(OMe)₃,
vinyl-Si(CH₃)₂—O—[Si(CH₃)₂—O]ₙ—Si(CH₃)₂-vinyl where n=0 to 10 000,
Me₃Si—O—(SiMe₂-O)ₙ—[Si(vinyl)Me-O]O—SiMe₃ where n=1 to 20 000 and o=1 to 20 000, acetylene, propyne, 1-butyne, 2-butyne and phenylacetylene.

In a particular embodiment, the compound A and the compound B are present in one molecule. Examples of such molecules are vinyldimethylsilane, allyldimethylsilane, vinylmethylchlorosilane and vinyldichlorosilane.

Compound C

Examples of radicals R^{y} in formula (III) are alkyl radicals, such as the methyl, ethyl, n-propyl, isopropyl, n-butyl, sec-butyl, isobutyl, tert-butyl, n-pentyl, sec-pentyl, isopentyl, neopentyl and tert-pentyl radical; hexyl radicals such as the n-hexyl radical; heptyl radicals such as the n-heptyl radical; octyl radicals such as the n-octyl radical, and isooctyl radicals such as the 2,4,4-trimethylpentyl radical; nonyl radicals such as the n-nonyl radical; decyl radicals such as the n-decyl radical; dodecyl radicals such as the n-dodecyl radical; hexadecyl radicals such as the n-hexadecyl radical; octadecyl radicals such as the n-octadecyl radical; cycloalkyl radicals, such as the cyclopentyl, cyclohexyl, cycloheptyl radical and methylcyclohexyl radical; aryl radicals, such as the phenyl, naphthyl, anthracene and phenanthrene radical; alkaryl radicals, such as the o-, m- and p-tolyl, xylyl, mesitylenyl and o-, m- and p-ethylphenyl radical; alkaryl radicals, such as the benzyl radical, the α- and the β-phenylethyl radical; and alkylsilyl radicals such as trimethylsilyl, triethylsilyl, tripropylsilyl, dimethylethylsilyl, dimethyltert-butylsilyl and diethylmethylsilyl radical.

In formula (III), the radicals R^{y} are preferably each independently selected from the group consisting of (i) C₁-C₃-alkyl radical, (ii) hydrogen and (iii) triorganosilyl radical of the formula —SiR^{b}₃, in which the radicals R^{b} are each independently C₁-C₂₀-alkyl radicals. The radicals R^{y} are particularly preferably each independently selected from the methyl radical and trimethylsilyl radical. All radicals R^{y} are especially preferably a methyl radical.

The index a in formula (III) is preferably 1, so that X⁻ is a monovalent anion.

Examples of anions X⁻ are:

halides;
chlorate ClO₄⁻;
tetrachlorometalates [MCl₄]⁻ where M=Al, Ga;
tetrafluoroborate [BF₄]⁻;
trichlorometalates [MCl₃]⁻ where M=Sn, Ge;
hexafluorometalates [MF₆]⁻ where M=As, Sb, Ir, Pt; perfluoroantimonates [Sb₂F₁₁]⁻, [Sb₃F₁₆]⁻ and [Sb₄F₂₁]⁻;
triflate (=trifluoromethanesulfonate) [OSO₂CF₃]⁻;
tetrakis(trifluoromethyl)borate [B(CF₃)₄]⁻; tetrakis(pentafluorophenyl) metalates [M(C₆F₅)₄]⁻
where M=Al, Ga;
tetrakis(pentachlorophenyl)borate [B(C₆Cl₅)₄]⁻;
tetrakis[(2,4,6-trifluoromethyl (phenyl)]borate {B[C₆H₂(CF₃)₃]}⁻;
[bis[tris(pentafluorophenyl)] hydroxide {HO[B(C₆F₅)₃]₂}⁻;
closo-carborates [CHB₁₁H₅Cl₆]⁻, [CHB₁₁H₅Br₆]⁻, [CHB₁₁(CH₃)₅Br₆]⁻, [CHB₁₁F₁₁]⁻, [C(Et)B₁₁F₁₁]⁻, [CB₁₁(CF₃)₁₂] and B₁₂Cl₁₁N(CH₃)₃]⁻;
tetra(perfluoroalkoxy)aluminates [Al(OR^{PF})₄]⁻ where R^{PF}=each independently perfluorinated C₁-C₁₄-hydrocarbon radical;
tris(perfluoroalkoxy)fluoroaluminates [FAl(OR^{PF})₃]⁻ where R^{PF}=each independently perfluorinated C₁-C₁₄-hydrocarbon radical;
hexakis(oxypentafluorooxotellurato) antimonate [Sb(OTeF₅)₆]⁻;
borates and aluminates of the formulae [B(R^{a})₄]⁻ and [Al(R^{a})₄]⁻, in which the radicals R^{a} are each independently selected from aromatic C₆-C₁₄-hydrocarbon radicals, in which at least one hydrogen atom has been mutually independently substituted by a radical selected from the group consisting of (i) fluorine, (ii) perfluorinated C₁-C₆-alkyl radical, and (iii) triorganosilyl radical of the formula —SiR^{b}₃, in which the radicals R^{b} are each independently C₁-C₂₀-alkyl radicals.

In formula (III), the anions X— are preferably selected from the group consisting of the compounds of the formulae [B(R^{a})₄]⁻ and [Al(R^{a})₄]⁻, in which the radicals R^{a} are in each case independently selected from aromatic C₆-C₁₄-hydrocarbon radicals in which at least one hydrogen atom has been mutually independently substituted by a radical selected from the group consisting of (i) fluorine, (ii) perfluorinated C₁-C₆-alkyl radical, and (iii) triorganosilyl radical of the formula —SiR^{b}₃, in which the radicals R^{b} are each independently C₁-C₂₀-alkyl radicals.

Examples of radicals R^{a} are the m-difluorophenyl radical, 2,2,4,4-tetrafluorophenyl radical, perfluorinated 1-naphthyl radical, perfluorinated 2-naphthyl radical, perfluorobiphenyl radical, —C₆F₅, —C₆H₃(m-CF₃)₂, —C₆H₄(p-CF₃), —C₆H₂(2,4,6-CF₃)₃, —C₆F₃(m-SiMe₃)₂, —C₆F₄(p-SiMe₃), —C₆F₄(p-SiMe₂t-butyl).

In formula (III), the anions X— are particularly preferably selected from the group consisting of the compounds of the formula [B(R^{a})₄]⁻, in which the radicals R^{a} are each independently selected from aromatic C₆-C₁₄-hydrocarbon radicals, in which all hydrogen atoms have been mutually independently substituted by a radical selected from the group consisting of (i) fluorine and (ii) triorganosilyl radical of the formula —SiR^{b}₃, in which the radicals R^{b} are each independently C₁-C₂₀-alkyl radicals.

In formula (III), the anions X— are especially preferably selected from the group consisting of the compounds of the formula [B(R^{a})₄]⁻, in which the radicals R^{a} are each independently selected from the group consisting of —C₆F₅, perfluorinated 1- and 2-naphthyl radical, —C₆F₃(SiR^{b}₃)₂ and —C₆F₄(SiR^{b}₃), in which the radicals R^{b} are in each case independently C₁-C₂₀-alkyl radicals.

In formula (III), the anions X— are most preferably selected from the group consisting of [B(C₆F₅)₄]⁻, [B(C₆F₄(4-TBS)₄]⁻ where TBS=SiMe₂tert-butyl, [B(2-NaphF)₄]⁻ where 2-NaphF=perfluorinated 2-naphthyl radical and [B(C₆F₅)₃(2-NaphF)]⁻ where 2-NaphF=perfluorinated 2-naphthyl radical.

Preferred compounds of the formula (III) are those in which all radicals Ry are methyl and the anions X— are selected from the group consisting of the compounds of the formulae [B(R^{a})₄]⁻, in which the radicals R^{a} are each independently selected from aromatic C₆-C₁₄-hydrocarbon radicals, in which at least one hydrogen atom has been mutually independently substituted by a radical selected from the group consisting of (i) fluorine, (ii) perfluorinated C₁-C₆-alkyl radical, and (iii) triorganosilyl radical of the formula —SiR^{b}₃, in which the radicals R^{b} are each independently C₁-C₂₀-alkyl radicals.

The compounds of the formula (III) are particularly preferably selected from the group consisting of Cp*Ge⁺ B(C₆F₅)₄⁻;

Cp*Ge⁺ B[C₆F₄(4-TBS)]₄⁻, where TBS=SiMe₂tert-butyl;
Cp*Ge⁺ B(2-NaphF)₄⁻, where 2-NaphF=perfluorinated 2-naphthyl radical; and
Cp*Ge⁺ B[(C₆F₅)₃(2-NaphF)]⁻, where 2-NaphF=perfluorinated 2-naphthyl radical.

The mixture M according to the invention may comprise any additional compounds such as processing aids, e.g. emulsifiers, fillers, for example highly dispersed silica or quartz, stabilizers, for example free radical inhibitors, pigments, for example dyes, or white pigments, for example chalk or titanium dioxide. The amounts of the further compounds are preferably between 0.1% by weight and 95% by weight, particularly preferably between 1% by weight and 80% by weight, very particularly preferably between 5% by weight and 30% by weight, based in each case on the total weight of the mixture M.

The invention further relates to a process for hydrosilylation of the mixture M according to the invention, wherein at least one compound A is reacted with at least one compound B in the presence of at least one compound C and in the presence of oxygen.

The amount of oxygen is not critical in the hydrosilylation; any oxygen-containing gas mixture known to those skilled in the art, such as ambient air, lean air, etc., can be used. The oxygen preferably originates from an oxygen-containing gas mixture having an oxygen content of 0.1-100% by volume.

It is also not critical when and how the oxygen is added. The oxygen-containing gas can, for example, be added once into the gas space, or it can be introduced continuously, or it can, prior to addition thereof, be passed over the cationic germanium(II) compound, or it can be introduced into a solution of the cationic germanium(II) compound, or it can be brought into contact with the reaction mixture via other methods known to those skilled in the art.

The reactants can be mixed with one another in any sequence, the mixing taking place in a manner known to those skilled in the art. For example, the compounds A, B and C can be mixed so that the hydrosilylation is initiated by contact with oxygen. It is also possible to first mix the compounds A and B or A and C or B and C and then to add the missing compound.

In a particular embodiment, the hydrosilylation of the mixture of the compounds A, B and C according to the invention is carried out under an air, lean air or oxygen atmosphere.

In a further particular embodiment, a solution of compound C is brought into contact with oxygen and mixed with compound A and compound B at a later point in time.

The molar ratio of the compounds A and B relative to the Si—H groups or unsaturated carbon moieties present, is typically in the range from 1:10 to 10:1, the molar ratio preferably being in the range from 1:5 to 5:1, particularly preferably in the range 1:2 to 2:1.

The molar ratio between the compound C and the Si—H groups present in the compound A is typically in the range from 1:10⁷ to 1:1, preferably in the range from 1:10⁶ to 1:10, particularly preferably in the range from 1:10⁵ to 1:500.

The hydrosilylation can be carried out without solvent or with the addition of one or more solvents. The proportion of solvent or solvent mixture, based on the sum of the compounds A and B, is preferably in the range from 0.1% by weight up to 1000-fold the amount by weight, particularly preferably in the range from 10% by weight to 100-fold the amount by weight, very particularly preferably in the range from 30% by weight up to 10-fold the amount by weight.

Solvents used may preferably be aprotic solvents, for example hydrocarbons such as pentane, hexane, heptane, cyclohexane or toluene, chlorinated hydrocarbons such as dichloromethane, chloroform, chlorobenzene or 1,2-dichloroethane, ethers such as diethyl ether, methyl tert-butyl ether, anisole, tetrahydrofuran or dioxane, or nitriles such as for example acetonitrile or propionitrile.

The pressure in the hydrosilylation can be freely selected by those skilled in the art; it can be carried out under ambient pressure or under reduced or elevated pressure.

The pressure is preferably in a range from 0.01 bar to 100 bar, particularly preferably in a range from 0.1 bar to 10 bar, the hydrosilylation being especially preferably carried out at ambient pressure. If, however, compounds are involved in the hydrosilylation that are present in gaseous form at the reaction temperature, the reaction is preferably carried out at elevated pressure, particularly preferably at the vapor pressure of the overall system.

The person skilled in the art can freely select the temperature of the hydrosilylation. The hydrosilylation is typically carried out at a temperature in the range from −100° C. to +250° C., preferably in the range from −20° C. to +150° C., particularly preferably in the range from 0° C. to 100° C.

The invention further relates to cationic germanium(II) compounds of the formula (IV)

[Cp*Ge]⁺[B(R^{a})₄]⁻ (IV),

in which Cp* is a π-bonded pentamethylcyclopentadienyl radical, and the radicals R^{a} are each independently selected from aromatic C₆-C₁₄-hydrocarbon radicals, in which at least one hydrogen atom has been mutually independently substituted by a radical selected from the group consisting of (i) fluorine, (ii) perfluorinated C₁-C₆-alkyl radical, and (iii) triorganosilyl radical of the formula —SiR^{b}₃, in which the radicals R^{b} are each independently C₁-C₂₀-alkyl radicals.

Examples of radicals R^{a} in formula (IV) are the m-difluorophenyl radical, 2,2,4,4-tetrafluorophenyl radical, perfluorinated 1-naphthyl radical, perfluorinated 2-naphthyl radical, perfluorobiphenyl radical, —C₆F, —C₆H₃(m-CF₃)₂, —C₆H₄(p-CF₃), —C₆H₂(2,4,6-CF₃)₃, —C₆F₃(m-SiMe₃)₂, —C₆F₄(p-SiMe₃), —C₆F₄(p-SiMe₂t-butyl).

In formula (IV), the radicals R^{a} are preferably each independently selected from aromatic C₆-C₁₄-hydrocarbon radicals, in which all hydrogen atoms have been mutually independently substituted by a radical selected from the group consisting of (i) fluorine and (ii) triorganosilyl radical of the formula —SiR^{b}₃, in which the radicals R^{b} are each independently C₁-C₂₀-alkyl radicals.

In formula (IV), the radicals R^{a} are especially preferably each independently selected from the group consisting of —C₆F, perfluorinated 1- and 2-naphthyl radical, —C₆F₃(SiR^{b}₃)₂ and —CF₄(SiR^{b}₃), in which the radicals R^{b} are each independently C₁-C₆-alkyl radicals.

In formula (IV), the radicals R^{a} are most preferably each independently selected from the group consisting of —C₆F, perfluorinated 2-naphthyl radical and —C₆F₄(4-SiMe₂tert-butyl).

Preferred compounds of the formula (IV) are:

Cp*Ge⁺ B(C₆F₅)₄⁻;
Cp*Ge⁺ B[C₆F₄(4-TBS)]₄⁻, where TBS=SiMe₂tert-butyl;
Cp*Ge⁺ B(2-NaphF)₄⁻, where 2-NaphF=perfluorinated 2-naphthyl radical; and
Cp*Ge⁺ B[(C₆F₅)₃(2-NaphF)]⁻, where 2-NaphF=perfluorinated 2-naphthyl radical.

The invention further relates to a method for preparing cationic germanium(II) compounds of the general formula (III)

([Ge(II)Cp]⁺)ₐX^{a-} (III),

wherein
(a) a compound of the general formula (V)

[Cp₂Ge(II)] (V),

in which the radicals Cp are each independently a π-bonded cyclopentadienyl radical of the general formula (Va)

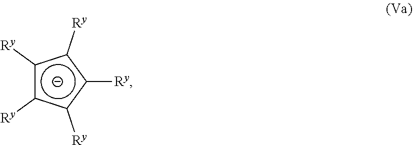

in which the radicals R^{y} are each independently selected from the group consisting of (i) triorganosilyl radical of the formula —SiR^{b}₃, in which the radicals R^{b} are each independently C₁-C₂₀-alkyl radicals, (ii) hydrogen, (iii) unsubstituted or substituted C₁-C₂₀-hydrocarbon radical, and (iv) unsubstituted or substituted C₁-C₂₀-hydrocarbonoxy radical, wherein in each case two radicals R^{y} can also form with each other a monocyclic or polycyclic C₂-C₂₀-hydrocarbon radical, and wherein substituted means in each case that in the hydrocarbon or hydrocarbonoxy radical also at least one carbon atom can be replaced by a Si atom, with the proviso that in at least one Cp radical at least one radical R^{y} is a —CHR¹R² group, in which R¹ and R² are each independently selected from the group consisting of (i) hydrogen, (ii) C₁-C₁₉-alkyl radical and (iii) C₆-C₁₉-aryl radical; is reacted
with
(b) a carbocationic compound of the general formula (VI)

(R^{d}₃C⁺)ₐX^{a-} (VI),

in which a can take the values 1, 2 or 3;
and in which X^{a-} is an a valent anion;
and in which the radicals R^{d} are each independently selected from unsubstituted or substituted, aromatic C₆-C₁₄-hydrocarbon radicals, wherein substituted means that the hydrocarbon radical each independently has at least one of the following substitutions: a hydrogen atom can be replaced by halogen or C₁-C₆-alkyl radical

The index a in formula (VI) is preferably 1, so that X⁻ is a monovalent anion.

In formula (VI), the anions X— are preferably selected from the group consisting of the compounds of the formula [B(R^{a})₄]⁻, in which the radicals R^{a} are in each case independently selected from aromatic C₆-C₁₄-hydrocarbon radicals in which at least one hydrogen atom has been mutually independently substituted by a radical selected from the group consisting of (i) fluorine, (ii) perfluorinated C₁-C₆-alkyl radical, and (iii) triorganosilyl radical of the formula —SiR^{b}₃, in which the radicals R^{b} are each independently C₁-C₂₀-alkyl radicals.

In formula (VI), the anions X— are particularly preferably selected from the group consisting of compounds of the formula [B(R^{a})₄]⁻, in which the radicals R^{a} are each independently selected from aromatic C₆-C₁₄-hydrocarbon radicals, in which all hydrogen atoms have been mutually independently substituted by a radical selected from the group consisting of (i) fluorine and (ii) triorganosilyl radical of the formula —SiR^{b}₃, in which the radicals R^{b} are each independently C₁-C₂₀-alkyl radicals.

In formula (VI), the anions X— are especially preferably selected from the group consisting of compounds of the formula [B(R^{a})₄]⁻, in which the radicals R^{a} are each independently selected from the group consisting of —C₆F₅, perfluorinated 1- or 2-naphthyl radical, —C₆F₃(SiR^{b}₃)₂ and —C₆F₄(SiR^{b}₃), in which the radicals R^{b} are each independently C₁-C₂₀-alkyl radicals.

In formula (VI), the anions X— are most preferably selected from the group consisting of [B(C₆F₅)₄]⁻, [B(C₆F₄(4-TBS)₄]⁻ where TBS=SiMe₂tert-butyl, [B(2-NaphF)₄]⁻ where 2-NaphF=perfluorinated 2-naphthyl radical and [B(C₆F₅)₃(2-NaphF)]⁻ where 2-NaphF=perfluorinated 2-naphthyl radical.

In formula (VI), the radicals R^{d} are preferably each independently selected from the group consisting of unsubstituted phenyl or phenyl substituted by halogen atoms, tolyl, xylyl, mesitylenyl and ethylphenyl radical.

In formula (VI), the radicals R^{d} are particularly preferably each independently selected from the group consisting of phenyl, pentafluorophenyl, pentachlorophenyl, o-tolyl, m-tolyl, p-tolyl, xylyl, mesitylenyl, m-ethylphenyl, o-ethylphenyl and p-ethylphenyl radical.

Preferred compounds of the formula (VI) are those in which all radicals R^{d} are phenyl and the anions X⁻ are selected from the group consisting of compounds of the formula [B(R^{a})₄]⁻, in which the radicals R^{a} are each independently selected from the group consisting of —C₆F₅, perfluorinated naphthyl radical and —C₆F₄(SiR^{b}₃), in which the radicals R^{b} are each independently C₁-C₂₀-alkyl radicals.

Examples of compounds of the formula (V) are:

decamethylgermanocene, decaisopropylgermanocene, and
octamethylbis(trimethylsilyl)germanocene, bis[(trimethylsilyl)cyclopentadienyl)] germanium,
bis[bis(trimethylsilyl)cyclopentadienyl] germanium,
bis[tris(trimethylsilyl]cyclopentadienyl]germanium.

Examples of compounds of the formula (VI) are:

(C₆H₅)₃C⁺ B(C₆F₅)₄⁻;
(C₆H₅)₃C⁺ B[C₆F₄(4-TBS)]₄⁻, where TBS=SiMe₂tert-butyl;
(C₆H₅)₃C⁺ B(2-NaphF)₄⁻, where 2-NaphF=perfluorinated 2-naphthyl radical; and
(C₆H₅)₃C⁺ B[(C₆F₅)₃(2-NaphF)]⁻, where 2-NaphF=perfluorinated 2-naphthyl radical.

The molar ratio of the compound of the general formula (V) and the carbocationic compound of the general formula (VI) is preferably at least 1:10 and at most 10:1, particularly preferably at least 1:5 and at most 5:1, especially preferably at least 1:3 and at most 3:1. The two components can be mixed in any sequence, the mixing being carried out in a manner known to those skilled in the art. The carbocationic compound of the general formula (VI) is preferably added to the compound of the general formula (V).

The reaction can be carried out in the presence of one or more further components, for example in the presence of a solvent or a mixture of two or more solvents. Either the compound of the general formula (V) or the carbocationic compound of the general formula (VI) or both components can be dissolved in a solvent or in a solvent mixture. The proportion of the solvent or solvent mixture relative to the sum of the compounds of the general formula (V) and (VI) is preferably at least 0.1% by weight and at most 1000-fold the weight, particularly preferably at least 10% by weight and at most 100-fold the weight, especially preferably at least 30% by weight and at most 10-fold the weight.

Solvents used may be, for example, hydrocarbons such as pentane, hexane, heptane, cyclohexane or toluene, chlorinated hydrocarbons such as dichloromethane, chloroform, chlorobenzene or 1,2-dichloroethane, ethers such as diethyl ether, methyl tert-butyl ether, anisole, tetrahydrofuran or dioxane, or nitriles such as acetonitrile or propionitrile.

The pressure in the reaction can be freely selected by those skilled in the art; it can be carried out under ambient pressure or under reduced or elevated pressure. The pressure is preferably not less than 0.01 bar and not more than 100 bar, more preferably not less than 0.1 bar and not more than 10 bar; most preferably the reaction is carried out at ambient pressure.

The person skilled in the art can freely select the reaction temperature. The reaction is typically carried out at a temperature in the range from −100° C. to +250° C., preferably in the range from −20° C. to +150° C., particularly preferably in the range from 0° C. to +100° C.

In a particular embodiment, the cationic germanium(II) compound of the general formula (III) is generated in situ in compound A or in compound B or in a mixture of the two compounds A and B.

In this way there is no need to isolate the cationic germanium(II) compound. For a hydrosilylation reaction, this means a reduction in the number of reaction stages, since the reaction of the compound A with the compound B starts directly with the formation of the cationic germanium(II) compound, provided that oxygen is present.

The invention further relates to a catalyst system comprising at least one cationic germanium(II) compound of the general formula (III) and oxygen.

The invention further relates to the use of the cationic germanium(II) compounds of the formula (III) as a catalyst, especially as a catalyst for hydrosilylations.

Particular preference is given to the use of the cationic germanium(II) compounds of the formula (IV) as a catalyst.

### EXAMPLES

The following tritylium salts were prepared analogously to the following literature references:

(C₆H₅)₃C⁺ B[C₆F₄(4-TBS)]₄⁻, TBS=SiMe₂tert-butyl: Marks et al., Organometallics 1997, 16, 842-857).
Decamethylgermanocene: Weidenbruch et al., J. Organomet. Chem. 2006, 691, 809-810. (C₆H₅)₃C⁺ B(Naph^{F})₄⁻ and (C₆H₅)₃C⁺ B[(C₆F₄)₃(Naph)]⁻ where Naph^{F}=perfluoro-ß-naphthyl: Mathur und Strickler, US 2015/0259362 (2017); Berris, WO2007/070770 (2007).

### Comparative Example 1 with Exclusion of Oxygen—Non-Inventive

All steps were carried out under argon. 2.0 mg (2.3 μmol) of Cp*Ge B(C₆F₅)₄⁻ were dissolved in 801 mg of CD₂Cl₂ and added to a mixture of 238 mg (2.01 mmol) of α-methylstyrene and 303 mg (2.03 mmol) of 1,1,3,3,3-pentamethyldisiloxane and the mixture shaken. The solution was analyzed by ¹H-NMR spectroscopy after 9 days. No hydrosilylation was detectable.

### Example 1: Preparation of Cp*Ge⁺ B(C₆F₅)₄⁻

Under an argon atmosphere, 701 mg (2.04 mmol) of decamethylgermanocene (Cp*₂Ge, Cp*=pentamethylcyclopentadienyl) were dissolved in 5 ml of dichloromethane and a solution of 1.70 g (1.83 mmol) of (C₆H₅)₃C⁺ B(C₆F₅)₄⁻ in 5 ml of dichloromethane was added slowly at room temperature with shaking. Subsequently, enough heptane was added as precipitant until no further precipitation of the product took place. The supernatant solution was decanted off, the precipitate was redissolved in dichloromethane and again precipitated with heptane. The precipitated product was filtered off under suction and dried, finally under high vacuum.

Yield: 1.63 g (97%), pale pink solid.

¹H-NMR (CD₂Cl₂): 6=2.23 (methyl groups).

¹³C-NMR (CD₂Cl₂): 6=8.82 (methyl groups), 6=123.1 (C's Cp*-Ring), 6=124 (broad), 6=135.3 (m), 6=137.3 (m), 6=139.2 (m), 6=147.2 (m), 6=149.1 (m): aromatic C—F.

¹¹B-NMR (CD₂Cl₂): δ=−16.66 (s).

¹⁹F-NMR (CD₂Cl₂): δ=−167.4 (mc, 8 ortho-F), δ=−163.5 (mc, 4 para-F), δ=−132.9 (m, broad, 8 meta-F).

The crystalline solid was stored in air for 4 days and showed no visible change; the NMR spectrum was identical to that of the freshly prepared pure substance.

### Example 2: Preparation of Cp*Ge⁺ B[C₆F₄(4-TBS)]₄⁻

365.1 mg (0.279 mmol) of (C₆H₅)₃C⁺ B[C₆F₄(4-TBS)]₄⁻ were dissolved in 965 mg of CD₂Cl₂ and the solution cooled to −30° C. 114.8 mg (0.335 mmol) of decamethylgermanocene (air-sensitive!) dissolved in ca. 350 mg of CD₂Cl₂ were slowly added under argon. The initially dark orange solution lightened to a pale yellowish color. 4 ml of pentane were added, the product precipitated as a beige solid and was washed with small portions of pentane. The solid was dried in vacuo. Yield: 300 mg (85%), beige solid.

¹H-NMR (CD₂Cl₂): δ=0.352 (s, 2 Si—CH₃), δ=0.913 s (Si-tert butyl), δ=2.17 (s, 15H, Cp*).

²⁹Si-NMR (CD₂Cl₂): δ=5.63 (s, aromatic silyl group)

¹⁹F-NMR (CD₂Cl₂): δ=−132.2 (m, 8F), δ=−130.4 (m, 8F).

### Example 3: Preparation of Cp*Ge⁺ B(Naph^{F})₄⁻ where Naph^{F}=Heptafluoro-ß-Naphthyl

The preparation was carried out as in example 2 by reacting decamethylgermanocene with (C₆H₅)₃C⁺ B(Naph^{F})₄⁻.

Yield: 92%, beige solid.

¹H-NMR (CD₂Cl₂): δ=2.22 (s, 15H, Cp*).

¹⁹F-NMR (CD₂Cl₂): δ=−161.3 to −160.9 (m, 4F), −159.8 to −159.4 (4F), −155.8 to −154.7 (4F), −150.2 to −149.8 (4F), −146.4 to −145.7 (4F), −125.9 to −124.4 (4F), −109.8 (mc, 1F), −109.3 (mc, 1F), −108.6 to −107.7 (m, 1F), −106.5 (mc, 1F).

¹¹B-NMR (CD₂Cl₂): δ=−13.80.

### Example 4: Preparation of Cp*Ge⁺ B[(C₆F₄)₃(Naph)]⁻ where Naph^{F}=Perfluoro-ß-Naphthyl

The preparation was carried out as in example 2 by reacting decamethylgermanocene with (C₆H₅)₃C⁺ B[(C₆F₄)₃(Naph^{F})]⁻.

Yield: 70%, beige solid.

¹H-NMR (CD₂Cl₂): δ=2.22 (s, 15H, Cp*).

¹¹B-NMR (CD₂Cl₂): δ=−16.45.

### Example 5: Hydrosilylation of α-Methylstyrene with Dimethylphenylsilane

207 mg (1.75 mmol) of α-methylstyrene and 229 mg (1.68 mmol) of dimethylphenylsilane together with 650 mg of CD₂Cl₂ were weighed into a reaction vessel under argon and 1.7 mg (1.92 μmol, 0.11 mol % based on dimethylphenylsilane) of Cp*Ge⁺ B(C₆F₅)₄⁻ in 160 mg CD₂Cl₂ were added. A syringe was used to inject 3 ml of air into the mixture. The reaction was complete after 24 hours at room temperature. This gave phenyl-CH(CH₃)—CH₂—Si(CH₃)₂Ph.

Product purity (GC)>90%,

¹H-NMR (CD₂Cl₂): δ=0.43 and 0.49 (s, 2 CH₃), δ=1.52 (mc, CH₂), δ=1.56 (d, CH3), δ=3.20 (mc, CH), δ=7.40-7.50 (m, 3 aromatic H), δ=7.50-7.58 (m, 2 aromatic H), δ=7.59-7.66 (m, 3 aromatic H), δ=7.76-7.82 (m, 2 aromatic H).

### Example 6: Hydrosilylation of α-Methylstyrene with Dimethylphenylsilane

120 mg (1.01 mmol) of α-methylstyrene and 137 mg (1.01 mmol) of dimethylphenylsilane together with 400 mg of CD₂Cl₂ were weighed into a reaction vessel under argon and 1.2 mg (0.94 μmol, 0.09 mol % based on dimethylphenylsilane) of Cp*Ge⁺ B(C₆F₅)₄⁻ in 130 mg CD₂Cl₂ were added. A syringe was used to inject 3 ml of air into the mixture. The reaction was complete after 24 hours at room temperature. This gave phenyl-CH(CH₃)—CH₂—Si(CH₃)₂Ph.

Product purity (GC)>90%,

¹H-NMR (CD₂Cl₂): δ=0.43 and 0.49 (s, 2 CH₃), δ=1.52 (mc, CH₂), δ=1.56 (d, CH3), δ=3.20 (mc, CH), δ=7.40-7.50 (m, 3 aromatic H), δ=7.50-7.58 (m, 2 aromatic H), δ=7.59-7.66 (m, 3 aromatic H), δ=7.76-7.82 (m, 2 aromatic H).

### Example 7: Hydrosilylation of α-Methylstyrene with Pentamethyldisiloxane

1.7 mg (1.9 μmol) of Cp*Ge⁺ B(C₆F₅)₄⁻ were dissolved in 890 mg of CD₂Cl₂ and a total of ca. 0.6 ml (ca. 30 μmol) of oxygen was introduced at room temperature over a period of 15 minutes with exclusion of air. The solution was added to a mixture of 208 mg (1.76 mmol) of α-methylstyrene and 260 mg (1.75 mmol) of 1,1,3,3,3-pentamethyldisiloxane and the mixture was shaken. After 3 hours the conversion was ca. 35% and after 24 hours conversion was complete. The hydrosilylation product formed was phenyl-CH(CH₃)—CH₂—Si(CH₃)₂—O—Si (CH₃)₃, which was verified by means of ¹H-NMR investigation in CD₂Cl₂ and comparison with an authentic sample.

### Example 8: Hydrosilylation of α-Methylstyrene with Pentamethyldisiloxane

1.7 mg (1.9 μmol) of Cp*Ge⁺ B(C₆F₅)₄⁻ were dissolved in 890 mg of CD₂Cl₂ and a total of ca. 8 ml (ca. 0.4 mmol) of oxygen was introduced at room temperature over a period of 3 hours with exclusion of air. The hydrosilylation was carried out as in Example 5. After 4 hours the conversion was ca. 83% and after 6 hours conversion was complete. The hydrosilylation product formed was phenyl-CH(CH₃)—CH₂—Si(CH₃)₂—O—Si (CH₃)₃, which was verified by means of ¹H-NMR investigation in CD₂Cl₂ and comparison with an authentic sample.

### Example 9: Hydrosilylation of α-Methylstyrene with Pentamethyldisiloxane

1.6 mg (1.8 μmol) of Cp*Ge⁺ B(C₆F₅)₄⁻ were dissolved in 900 mg of CD₂Cl₂ and a total of ca. 1.2 ml (ca. 60 μmol) of oxygen were introduced at room temperature over a period of 30 minutes with exclusion of air. After a standing time of 23 hours, the hydrosilylation was carried out with this solution as in example 5. After 3 hours the conversion was ca. 65% and after 15 hours conversion was complete. The hydrosilylation product formed was phenyl-CH(CH₃)—CH₂—Si(CH₃)₂—O—Si (CH₃)₃, which was verified by means of ¹H-NMR investigation in CD₂Cl₂ and comparison with an authentic sample.

### Example 10: Hydrosilylation of α-Methylstyrene with Pentamethyldisiloxane

299 mg (2.01 mmol) of pentamethyldisiloxane and 248 mg (2.10 mmol) of α-methylstyrene are mixed and a solution of 2.5 mg (2.03 μmol, 0.1 mol %) of Cp*Ge⁺ B(Naph^{F})₄⁻ in 361 mg of CD₂Cl₂ was added under argon. 1 ml of air is added 3 times in succession to the gas space above the solution and the mixture shaken for ca. 30 seconds each time. The hydrosilylation is monitored by ¹H-NMR spectroscopy at room temperature. The conversion is 35% after 6 hours.

### Example 11: Hydrosilylation of 1-hexene with 1,1,3,3,3-pentamethyldisiloxane

139 mg (1.66 mmol) of 1-hexene, 203 mg (1.37 mmol) of 1,1,3,3,3-pentamethyldisiloxane and 500 mg CD₂Cl₂ and a solution of 2.8 mg (3.16 μmol, 0.23 mol % based on 1,1,3,3,3-pentamethyldisiloxane) of Cp*Ge⁺ B(C₆F₅)₄⁻ in 170 mg CD₂Cl₂ were mixed in a reaction vessel under argon. 3 ml of air (ca. 0.8 mg of O₂, corresponds to ca. 25 μmol) were added to the gas space using a syringe, the vessel sealed and heated at 45° C. for 4 hours. The gas chromatographic analysis showed a conversion of 90%. The main product of the reaction is CH₃—(CH₂)₅—Si(CH₃)₂—O—Si(CH₃)₃. The identification was carried out by comparison with an authentic substance sample.

### Example 12: Hydrosilylation of α-methylstyrene with 1,1,3,3,3-pentamethyldisiloxane

The working steps were carried out in air at room temperature.

815 mg (6.90 mmol) of α-methylstyrene and 1116 mg (7.52 mmol) of 1,1,3,3,3-pentamethyldisiloxane were mixed and 1.1 mg (0.865 mmol, 0.0125 mol % based on α-methylstyrene) of Cp*Ge⁺ B[C₆F₄(4-TBS)]₄⁻ were added. Conversion was complete after 24 hours. The hydrosilylation product formed was phenyl-CH(CH₃)—CH₂—Si(CH₃)₂—O—Si (CH₃)₃, which was verified by means of ¹H-NMR investigation in CD₂Cl₂ and comparison with an authentic sample.

### Example 13: Hydrosilylation of α-methylstyrene with 1,1,3,3,3-pentamethyldisiloxane

The working steps were carried out in air at room temperature.

805 mg (6.81 mmol) of α-methylstyrene and 1009 mg (6.80 mmol) of 1,1,3,3,3-pentamethyldisiloxane were mixed and a solution of 9.2 mg (7.23 μmol, 0.106 mol % based on 1,1,3,3,3-pentamethyldisiloxane) of Cp*Ge⁺ B[C₆F₄(4-TBS)]₄⁻ dissolved in 941 mg of CD₂Cl₂ was added with stirring. The mixture was diluted with a further 924 mg of CD₂Cl₂. After 3 hours the conversion was 91% and after 24 hours conversion was complete. The hydrosilylation product formed was phenyl-CH(CH₃)—CH₂—Si(CH₃)₂—O—Si(CH₃)₃, which was verified by means of ¹H-NMR investigation in CD₂Cl₂ and comparison with an authentic sample.

After further addition of a mixture of 301 mg (2.55 mmol) of α-methylstyrene and 376 mg (2.53 mmol) of 1,1,3,3,3-pentamethyldisiloxane, the conversion was again complete after 24 hours, i.e. the product solution still contained active germanium(II) species.

After further addition of a mixture of 806 mg (6.82 mmol) of α-methylstyrene and 1003 mg (6.76 mmol) of 1,1,3,3,3-pentamethyldisiloxane, the conversion was again complete after 24 hours, i.e. the product solution still contained active germanium(II) species.

### Example 14: Hydrosilylation of α-methylstyrene with 1,1,3,3,3-pentamethyldisiloxane

The working steps were carried out in air at room temperature.

801 mg (6.78 mmol) of α-methylstyrene and 1005 mg (6.78 mmol) of 1,1,3,3,3-pentamethyldisiloxane were mixed, 900 mg of CD₂Cl₂ were added and a solution of 0.9 mg (0.708 μmol, 0.010 mol % based on 1,1,3,3,3-pentamethyldisiloxane) of Cp*Ge⁺ B[C₆F₄(4-TBS)]₄⁻ dissolved in 922 mg of CD₂Cl₂ was added with stirring. The reaction was complete after 24 hours. The hydrosilylation product formed was phenyl —CH(CH₃)—CH₂—Si(CH₃)₂—O— Si(CH₃)₃, which was verified by means of ¹H-NMR investigation in CD₂Cl₂ and comparison with an authentic sample.

### Example 15: Hydrosilylation of α-methylstyrene with 1,1,3,3,3-pentamethyldisiloxane

In a glove box, under an argon atmosphere, 300 mg (2.02 mmol) of 1,1,3,3,3-pentamethyldisiloxane and 242 mg (2.05 mmol) of α-methylstyrene were mixed in an NMR tube and a solution of 1.9 mg (2.1 μmol) of Cp*Ge⁺ B(C₆F₅)₄⁻ in 807 mg of d⁸-toluene was added. After 9 days storage under argon, no reaction had taken place. The tube was opened and 1 ml of air (ca. 9 μmol of oxygen) was added. After 24 hours the conversion was 53% and after a further 3 days hydrosilylation was complete. The hydrosilylation product formed was phenyl —CH(CH₃)—CH₂—Si(CH₃)₂—O—Si(CH₃)₃, which was verified by means of ¹H-NMR investigation in d⁸-toluene and comparison with an authentic sample.

### Example 16: Hydrosilylation of α-methylstyrene with 1,1,3,3,3-pentamethyldisiloxane

The experiment according to Example 15 was repeated using CD₂Cl₂ instead of d⁸-toluene. After 9 days storage under argon, no reaction had taken place. The tube was opened and 1 ml of air (ca. 9 μmol of oxygen) was added. After 24 hours the conversion was 33% and after 2 days conversion was complete. The hydrosilylation product formed was phenyl-CH(CH₃)—CH₂—Si(CH₃)₂—O—Si(CH₃)₃, which was verified by means of ¹H-NMR investigation in CD₂Cl₂ and comparison with an authentic sample.

### Example 17: Hydrosilylation of Phenylacetylene with Triethylsilane

150 mg (1.47 mmol) of phenylacetylene, 171 mg (1.47 mmol) of triethylsilane and 616 mg of CD₂Cl₂ were mixed in a reaction vessel under argon and a solution of 1.4 mg (1.58 μmol, 0.11 mol % based on reactants) of Cp*Ge⁺ B(C₆F₅)₄⁻ in 100 mg CD₂Cl₂ were added. 3 ml of air (ca. 0.8 mg of 02, corresponds to ca. 25 μmol) were added to the gas space using a syringe, the vessel sealed and heated at 50° C. for 40 hours. The following hydrosilylation products were detected in the specified proportions by gas chromatographic and GC/MS analysis: 60% Ph-CH═CH-SiEt₃, 10% Ph-CH₂—CH(SiEt₃)₂.

### Example 18: Hydrosilylation of 1-Hexyne with Triethylsilane

The reaction was carried out as in Example 17 at 50° C. with 103 mg (1.26 mmol) of 1-hexyne, 142 mg (1.22 mmol) of triethylsilane, 1.2 g of dichloromethane and 1.3 mg (1.41 μmol) of Cp*Ge⁺ B(C₆F₅)₄⁻ in 100 mg of CD₂Cl₂. The reaction time was 19 hours. Ca. 30% C₄H₉—CH═CH-SiEt₃ were detected by gas chromatographic and GC/MS analysis.

1-23. (canceled)

24. A mixture M comprising
(a) at least one compound A selected from
(a1) a compound of the general formula (I)
R¹R²R³Si—H (I),
in which the radicals R¹, R² and R³ are each independently selected from the group consisting of (i) hydrogen, (ii) halogen, (iii) unsubstituted or substituted C₁-C₂₀-hydrocarbon radical, and (iv) unsubstituted or substituted C₁-C₂₀-hydrocarbonoxy radical, where two of the radicals R¹, R² and R³ may also form with each other a monocyclic or polycyclic, unsubstituted or substituted C₂-C₂₀-hydrocarbon radical, wherein substituted means in each case that the hydrocarbon or hydrocarbonoxy radical each independently has at least one of the following substitutions: a hydrogen atom can be replaced by halogen, —C≡N, —OR^{z}, —SR^{z}, —NR^{z}₂, —PR^{z}₂, —O—CO—R^{z}, —NH—CO—R^{z}, —O—CO—OR^{z} or —COOR^{z}, a CH₂ group can be replaced by —O—, —S— or —NR^{z}—, and a carbon atom can be replaced by a Si atom, in which R^{z} is in each case independently selected from the group consisting of hydrogen, C₁-C₆-alkyl radical, C₆-C₁₄-aryl radical, and C₂-C₆-alkenyl radical; and/or
(a2) a compound of the general formula (I′)
(SiO_{4/2})ₐ(R^{x}SiO_{3/2})_{b}(HSiO_{3/2})_{b′}(R^{x}₂SiO_{2/2})_{c}(R^{x}HSiO_{2/2})_{c′}(H₂SiO_{2/2})_{c″}(R^{x}₃SiO_{1/2})_{d}(HR^{x}₂SiO_{1/2})_{d′}(H₂R^{x}SiO_{1/2})_{d″}(H₃SiO_{1/2})_{d′″} (I′),
in which the radicals R^{x} are each independently selected from the group consisting of (i) halogen, (ii) unsubstituted or substituted C₁-C₂₀-hydrocarbon radical, and (iii) unsubstituted or substituted C₁-C₂₀-hydrocarbonoxy radical, wherein substituted means in each case that the hydrocarbon or hydrocarbonoxy radical each independently has at least one of the following substitutions: a hydrogen atom can be replaced by halogen, a CH₂ group can be replaced by —O— or —NR^{z}—, in which R^{z} is in each case independently selected from the group consisting of hydrogen, C₁-C₆-alkyl radical, C₆-C₁₄-aryl radical, and C₂-C₆-alkenyl radical;
and in which the indices a, b, b′, c, c′, c″, d, d′, d″, d′″ specify the number of the respective siloxane unit in the compound and are each independently an integer in the range from 0 to 100 000, with the proviso that the sum of a, b, b′, c, c′, c″, d, d′, d″, d′″ together has the value of at least 2 and at least one of the indices b′, c′, c″, d′, d″ or d′″ is not equal to 0; and
(b) at least one compound B selected from
(b1) a compound of the general formula (II)
R⁴R⁵C═CR⁶R⁷ (II), and/or
(b2) a compound of the general formula (II′)
R⁸C≡CR⁹ (II′)
in which the radicals R⁴, R⁵, R⁶, R⁷, R⁸ and R⁹ are each independently selected from the group consisting of (i) hydrogen, (ii) —C≡N, (iii) organosilicon radical having 1-100 000 silicon atoms, (iv) unsubstituted or substituted C₁-C₂₀-hydrocarbon radical, and (v) unsubstituted or substituted C₁-C₂₀-hydrocarbonoxy radical, where two of the radicals R⁴, R⁵, R⁶ and R⁷ may also form with each other a monocyclic or polycyclic, unsubstituted or substituted C₂-C₂₀-hydrocarbon radical, wherein substituted means in each case that the hydrocarbon or hydrocarbonoxy radical each independently has at least one of the following substitutions: a hydrogen atom can be replaced by halogen, —C≡N, —OR^{z}, —SR^{z}, —NR^{z}₂, —PR^{z}₂, —O—CO—R^{z}, —NH—CO—R^{z}, —O—CO—OR^{z}, —COOR^{z} or —[O—(CH₂)ₙ]ₒ—(CH(O)CH₂) where n=1-6 and o=1-100, a CH₂ group can be replaced by —O—, —S— or —NR^{z}—, and a carbon atom can be replaced by a Si atom, in which R^{z} is in each case independently selected from the group consisting of hydrogen, C₁-C₆-alkyl, C₆-C₁₄-aryl, and C₂-C₆-alkenyl; and/or
b3) a compound (or a mixture of compounds) of the general formula (II″)
R^{x}₃Si—O[—SiR^{x}₂—O]ₘ—[Si(MB)R^{x}—O]ₙ—SiR^{x}₃ (II″),
in which the radicals R^{x} are each independently selected from the group consisting of (i) hydrogen, (ii) halogen, (iii) MB, (iv) unsubstituted or substituted C₁-C₂₀-hydrocarbon radical, and (v) unsubstituted or substituted C₁-C₂₀-hydrocarbonoxy radical;
and in which MB is each independently (i) —(CH₂)ₒ—CR═CR₂ or (ii) —(CH₂)ₒ—C≡CR, where o=0-12 and R is in each case independently selected from the group consisting of (i) hydrogen, (ii) halogen, (iii) unsubstituted or substituted C₁-C₂₀-hydrocarbon radical, and (iv) unsubstituted or substituted C₁-C₂₀-hydrocarbonoxy radical, wherein substituted means in each case that the hydrocarbon or hydrocarbonoxy radical each independently has at least one of the following substitutions: a hydrogen atom can be replaced by halogen, —C≡N, —OR^{z}, —SR^{z}, —NR^{z}₂, —PR^{z}₂, —O—CO—R^{z}, —NH—CO—R^{z}, —O—CO—OR^{z} or —COOR^{z}, a CH₂ group can be replaced by —O—, —S— or —NR^{z}—, and a carbon atom can be replaced by a Si atom, in which R^{z} is in each case independently selected from the group consisting of hydrogen, C₁-C₆-alkyl radical, C₆-C₁₄-aryl radical, and C₂-C₆-alkenyl radical;
and in which m and n are each independently an integer in the range from 0 to 100 000, with the proviso that at least one radical MB is present in the compound; and
(c) at least one compound C selected from the cationic germanium(II) compound of the general formula (III)
([Ge(II)Cp]⁺)ₐX^{a-} (III),
in which Cp is a π-bonded cyclopentadienyl radical of the general formula (IIIa) 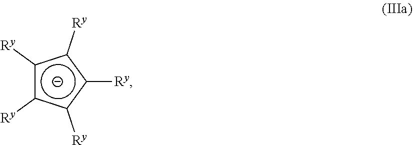
in which the radicals R^{y} are each independently selected from the group consisting of (i) triorganosilyl radical of the formula —SiR^{b}₃, in which the radicals R^{b} are each independently C₁-C₂₀-hydrocarbon radical, (ii) hydrogen, (iii) unsubstituted or substituted C₁-C₂₀-hydrocarbon radical, and (iv) unsubstituted or substituted C₁-C₂₀-hydrocarbonoxy radical, wherein in each case two radicals R^{y} can also form with each other a monocyclic or polycyclic C₂-C₂₀-hydrocarbon radical, and wherein substituted means in each case that in the hydrocarbon or hydrocarbonoxy radical also at least one carbon atom can be replaced by a Si atom.
X^{a-} is an a valent anion; and
a can have the values 1, 2 or 3.

25. The mixture M as claimed in claim 24, wherein in formula (I) the radicals R¹, R² and R³ are each independently selected from the group consisting of (i) hydrogen, (ii) chlorine, (iii) unsubstituted or substituted C₁-C₁₂-hydrocarbon radical, and (iv) unsubstituted or substituted C₁-C₁₂-hydrocarbonoxy radical, wherein substituted has the same definition as before; and in formula (I′) the radicals R^{x} are each independently selected from the group consisting of chlorine, C₁-C₆-alkyl radical, C₂-C₆-alkenyl radical, phenyl, and C₁-C₆-alkoxy radical, and the indices a, b, b′, c, c′, c″, d, d′, d″, d′″ are each independently selected from an integer in the range of 0 to 1.

26. The mixture M as claimed in claim 25, wherein in formula (I) the radicals R¹, R² and R³ are each independently selected from the group consisting of (i) hydrogen, (ii) chlorine, (iii) C₁-C₆-alkyl radical, (iv) C₂-C₆-alkenyl radical, (v) phenyl, and (vi) C₁-C₆-alkoxy radical; and in formula (I′) the radicals R^{x} are each independently selected from the group consisting of chlorine, methyl, methoxy, ethyl, ethoxy, n-propyl, n-propoxy, and phenyl, and the indices a, b, b′, c, c′, c″, d, d′, d″, d′″ are each independently selected from an integer in the range from 0 to 1000.

27. The mixture M as claimed in claim 26, wherein in formula (I) the radicals R¹, R² and R³ and in formula (I′) the radicals R^{x} are each independently selected from the group consisting of hydrogen, chlorine, methyl, methoxy, ethyl, ethoxy, n-propyl, n-propoxy, and phenyl, and the indices a, b, b′, c, c′, c″, d, d′, d″, d′″ are each independently selected from an integer in the range from 0 to 1000.

28. The mixture M as claimed in claim 24, wherein in the formulae (II) and (II′) the radicals R⁴, R⁵, R⁶, R⁷, R⁸ and R⁹ are each independently selected from the group consisting of (i) hydrogen, (ii) —C≡N, (iii) unsubstituted or substituted C₁-C₁₂-hydrocarbon radical, (iv) unsubstituted or substituted C₁-C₁₂-hydrocarbonoxy radical, wherein two of the radicals R⁴, R⁵, R⁶ and R⁷ may also form with each other a monocyclic or polycyclic, unsubstituted or substituted C₂-C₂₀-hydrocarbon radical, wherein substituted means in each case that the hydrocarbon or hydrocarbonoxy radical each independently has at least one of the following substitutions: a hydrogen atom can be replaced by halogen, —C≡N, C₁-C₆-alkoxy, —NR^{z}₂, —O—CO—R^{z}, —NH—CO—R^{z}, —O—CO—OR^{z}, —COOR^{z} or —[O—(CH₂)ₙ]ₒ—(CH(O)CH₂) where n=1-3 and o=1-20, in which R^{z} is in each case independently selected from the group consisting of hydrogen, chlorine, C₁-C₆-alkyl, C₂-C₆-alkenyl, and phenyl; and (v) organosilicon radical selected from the general formula (IIa),
—(CH₂)ₙ—SiR^{x}₃ (IIa),
in which the radicals R^{x} are each independently selected from the group consisting of (i) hydrogen, (ii) halogen, (iii) unsubstituted or substituted C₁-C₂₀-hydrocarbon radical, and (iv) unsubstituted or substituted C₁-C₂₀-hydrocarbonoxy radical, wherein substituted means in each case that the hydrocarbon or hydrocarbonoxy radical each independently has at least one of the following substitutions: a hydrogen atom can be replaced by halogen, a CH₂ group can be replaced by —O— or —NR^{z}—, in which R^{z} is selected from the group consisting of hydrogen, C₁-C₆-alkyl, C₆-C₁₄-aryl, and C₂-C₆-alkenyl;
and in which n=0-12;
and where in formula (II″) the radicals R^{x} are each independently selected from the group consisting of (i) hydrogen, (ii) chlorine, (iii) C₁-C₆-alkyl radical, (iv) phenyl, (v) MB and (vi) C₁-C₆-alkoxy radical, where MB is in each case independently (i) —(CH₂)ₒ—CR═CR₂ or (ii) —(CH₂)ₒ—C≡CR, where o=0-6 and in which R is in each case independently selected from the group consisting of (i) hydrogen, (ii) chlorine, (iii) C₁-C₆-alkyl radical, (iv) phenyl, and (v) C₁-C₆-alkoxy radical.

29. The mixture M as claimed in claim 28, wherein in the formula (II) and (II′) the radicals R⁴, R⁵, R⁶, R⁷, R⁸ and R⁹ are each independently selected from the group consisting of (i) hydrogen, (ii) —C≡N, (iii) organosilicon radical having 1-100 000 silicon atoms selected from the general formula (IIa), in which the radicals R^{x} are each independently selected from the group consisting of hydrogen, chlorine, C₁-C₆-alkyl radical, C₂-C₆-alkenyl radical, phenyl and C₁-C₆-alkoxy radical; (iv) unsubstituted or substituted C₁-C₆-hydrocarbon, and (v) unsubstituted or substituted C₁-C₆-hydrocarbonoxy radical, wherein substituted means in each case that the hydrocarbon or hydrocarbonoxy radical has each independently at least one of the following substitutions: a hydrogen atom can be replaced by chlorine, —C≡N, —O—CH₂—(CH(O)CH₂) (=glycidoxy radical), —NR^{z}₂ and —O—CO—R^{z}, wherein R^{z} is in each case independently selected from the group consisting of hydrogen and C₁-C₆-alkyl;
and where in formula (II″) the radicals R^{x} are each independently selected from the group consisting of
C₁-C₃-alkyl radical and MB, where MB is in each case —(CH₂)O—CR═CR₂, in which R is in each case hydrogen and o=0-6.

30. The mixture M as claimed in claim 24, wherein in formula (III) the radicals R^{y} are each independently selected from the group consisting of (i) C₁-C₃-alkyl radical and (ii) triorganosilyl radical of the formula —SiR^{b}₃, in which the radicals R^{b} are each independently C₁-C₂₀-alkyl radicals.

31. The mixture M as claimed in claim 30, wherein in formula (III) the anions X— are selected from the group consisting of the compounds of the formulae [B(R^{a})₄]⁻ and [Al(R^{a})₄]⁻, in which the radicals R^{a} are in each case independently selected from aromatic C₆-C₁₄-hydrocarbon radicals in which at least one hydrogen atom has been mutually independently substituted by a radical selected from the group consisting of (i) fluorine, (ii) perfluorinated C₁-C₆-alkyl radical, and (iii) triorganosilyl radical of the formula —SiR^{b}₃, in which the radicals R^{b} are each independently C₁-C₂₀-alkyl radicals.

32. The mixture M as claimed in claim 31, wherein in formula (III) all radicals R^{y} are methyl and the anions X— are selected from the group consisting of the compounds of the formulae [B(R^{a})₄]⁻, in which the radicals R^{a} are each independently selected from aromatic C₆-C₁₄-hydrocarbon radicals, in which all hydrogen atoms have been mutually independently substituted by a radical selected from the group consisting of (i) fluorine and (ii) triorganosilyl radicals of the formula —SiR^{b}₃, in which the radicals R^{b} are each independently C₁-C₂₀-alkyl radicals.

33. The mixture M as claimed in claim 32, wherein the compound C is selected from the group consisting of Cp*Ge⁺ B(C₆F₅)₄⁻; Cp*Ge⁺ B[C₆F₄(4-TBS)]₄⁻, where TBS=SiMe₂tert-butyl; Cp*Ge⁺ B(2-NaphF)₄⁻, where 2-NaphF=perfluorinated 2-naphthyl radical; and Cp*Ge⁺ B[(C₆F₅)₃(2-NaphF)]⁻, where 2-NaphF=perfluorinated 2-naphthyl radical.

34. A process for hydrosilylation of the mixture M as claimed in claim 24, wherein at least one compound A is reacted with at least one compound B in the presence of at least one compound C and in the presence of oxygen.

35. The process as claimed in claim 34, wherein the temperature is in a range from −100° C. to +250° C. and the pressure is in a range from 0.01 bar to 100 bar.

36. The process as claimed in claim 34, wherein the oxygen originates from an oxygen-containing gas mixture having an oxygen content of 0.1-100% by volume.

37. The process as claimed in claim 36, wherein the reaction is carried out under an air, lean air or oxygen atmosphere.

38. The process as claimed in claim 34, wherein the molar ratio between the compound C and the Si—H groups present in the compound A is in a range from 1:10⁷ to 1:1.

39. A cationic germanium(II) compound of the general formula (IV)
[Cp*Ge]⁺[B(R^{a})₄]⁻ (IV),
in which Cp* is a π-bonded pentamethylcyclopentadienyl radical, and the radicals R^{a} are each independently selected from aromatic C₆-C₁₄-hydrocarbon radicals, in which at least one hydrogen atom has been mutually independently substituted by a radical selected from the group consisting of (i) fluorine, (ii) perfluorinated C₁-C₆-alkyl radical, and (iii) triorganosilyl radical of the formula —SiR^{b}₃, in which the radicals R^{b} are each independently C₁-C₂₀-alkyl radicals.

40. The cationic germanium(II) compound as claimed in claim 39, wherein the radicals R^{a} are each independently selected from aromatic C₆-C₁₄-hydrocarbon radicals, in which all hydrogen atoms have been mutually independently substituted by a radical selected from the group consisting of (i) fluorine and (ii) triorganosilyl radical of the formula —SiR^{b}₃, in which the radicals R^{b} are each independently C₁-C₂₀-alkyl radicals.

41. The cationic germanium (II) compound as claimed in claim 40, wherein the compound is selected from the group consisting of Cp*Ge⁺ B(C₆F₅)₄⁻;
Cp*Ge⁺ B[C₆F₄(4-TBS)]₄⁻, where TBS=SiMe₂tert-butyl;
Cp*Ge⁺ B(2-NaphF)₄⁻, where 2-NaphF=perfluorinated 2-naphthyl radical; and
Cp*Ge⁺ B[(C₆F₅)₃(2-NaphF)]⁻, where 2-NaphF=perfluorinated 2-naphthyl radical.

42. A method for preparing cationic germanium(II) compounds of the general formula (III)
([Ge(II)Cp]⁺)ₐX^{a-} (III)
wherein
(a)[Cp₂Ge(II)] (V),
in which the radicals Cp are each independently a π-bonded cyclopentadienyl radical of the general formula (Va) 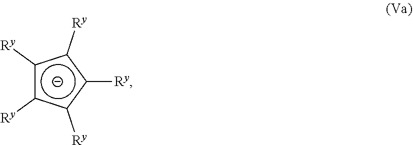
in which the radicals R^{y} are each independently selected from the group consisting of (i) triorganosilyl radical of the formula —SiR^{b}₃, in which the radicals R^{b} are each independently C₁-C₂₀-alkyl radicals, (ii) hydrogen, (iii) unsubstituted or substituted C₁-C₂₀-hydrocarbon radical, and (iv) unsubstituted or substituted C₁-C₂₀-hydrocarbonoxy radical, wherein in each case two radicals R^{y} can also form with each other a monocyclic or polycyclic C₂-C₂₀-hydrocarbon radical, and wherein substituted means in each case that in the hydrocarbon or hydrocarbonoxy radical also at least one carbon atom can be replaced by a Si atom, with the proviso that in at least one Cp radical at least one radical R^{y} is a —CHR¹R² group, in which R¹ and R² are each independently selected from the group consisting of (i) hydrogen, (ii) C₁-C₁₉-alkyl radical and (iii) C₆-C₁₉-aryl radical; is reacted with
(b) a carbocationic compound of the general formula (VI)
(R^{d}₃C⁺)ₐX^{a-} (VI),
in which a can take the values 1, 2 or 3; and in which X^{a-} is an a valent anion; and in which the radicals R^{d} are each independently selected from unsubstituted or substituted, aromatic C₆-C₁₄-hydrocarbon radicals, wherein substituted means that the hydrocarbon radical each independently has at least one of the following substitutions: a hydrogen atom can be replaced by halogen or C₁-C₆-alkyl radical.

43. A catalyst system comprising at least one cationic germanium(II) compound of the general formula (IV) according to claim 39 and oxygen.

44. The use of cationic germanium(II) compounds of the general formula (III) according to claim 24 as a catalyst.

45. The use as claimed in claim 44, wherein the cationic germanium(II) compound is one of the general formula (IV) according to claim 39.
